(19) United States
(12) Patent Application Publication
(10) Pub. No.: US 2020/0057359 A1
(43) Pub. Date: Feb. 20, 2020

(54) ILLUMINATION OPTICAL SYSTEM AND IMAGE PROJECTOR

(71) Applicant: SONY CORPORATION, TOKYO (JP)

(72) Inventor: TAKAHIRO TOMARU, AICHI (JP)

(21) Appl. No.: 16/487,480

(22) PCT Filed: Feb. 19, 2018
(86) PCT No.: PCT/JP2018/005711

§ 371 Date: Aug. 21, 2019

(30) Foreign Application Priority Data
Mar. 24, 2017 (JP) 2017-059756

(51) Int. Cl. G03B 21/20

(52) U.S. Cl. CPC G03B 21/2093; G03B 21/16

(57) ABSTRACT

Provided is an image projector having satisfactory display performance. The image projector includes an optical device group including a light source, a container accommodating the optical device group, and a seal attached to the container to cover the optical device group and sealing in the optical device group.

### TECHNICAL FIELD

The present disclosure relates to an illumination optical system, and an image projector including the illumination optical system and a projection optical system.

### BACKGROUND ART

A projector (image projector) has been heretofore known that includes an illumination optical system (illumination device) using a halogen lamp, a metal halide lamp or the like as a light source, and a projection optical system (projection optical system) including a light modulating device and a projector lens (refer to PTL 1).

### CITATION LIST

### Patent Literature

Patent Literature 1: Japanese Unexamined Patent Application Publication No. 2011-2611

### SUMMARY OF THE INVENTION

Recently, small (palm-sized), lightweight portable projectors known as microprojectors in the field of such projectors have become popular. In such microprojectors, light emitting diodes (LEDs) are mainly used as light sources of illumination devices. More recently, lasers have also been drawing attention from the viewpoint of expansion of the range of color reproduction and reduction of power consumption.

If dust, such as cigarette smoke or dirt, for example, flows into an illumination optical system provided with several optical devices including such a light source, there is a concern of degradation of the optical performance of these optical devices.

Thus, it is desirable to provide image projectors that are able to achieve good display performance and illumination optical systems used in the image projectors.

An illumination optical system according to an embodiment of the present disclosure includes an optical device group including a light source, a container accommodating the optical device group, and a seal attached to the container to cover the optical device group, the seal sealing in the optical device group.

The image projector according to an embodiment of the present disclosure includes an illumination optical system and a projection optical system. The illumination optical system includes an optical device group including a light source, a container accommodating the optical device group, and a first seal attached to the container to cover the optical device group, the first seal sealing in the optical device group.

In the illumination optical system according to an embodiment of the present disclosure, the optical device group is accommodated in the container and sealed in by the seal (first seal). This suppresses degradation of the optical performance due to the influence of dust. Thus, the image projector including the illumination optical system enables satisfactory display performance.

Note that the effects of the present disclosure are not limited thereto and may include any of those described below.

### BRIEF DESCRIPTION OF THE DRAWINGS

FIG. 1 is a schematic view of an overall configuration example of an image projector according to an embodiment of the present disclosure.

FIG. 2A is an exploded perspective view of the image projector illustrated in FIG. 1.

FIG. 2B is another exploded perspective view of the image projector illustrated in FIG. 1.

FIG. 3A is an exploded perspective view of the illumination optical system illustrated in FIG. 2A.

FIG. 3B is another exploded perspective view of the illumination optical system illustrated in FIG. 2A.

FIG. 4A is a first plan view of the image projector illustrated in FIG. 1 as seen from above.

FIG. 4B is a second plan view of the image projector illustrated in FIG. 1 as seen from above.

FIG. 4C is a third plan view of the image projector illustrated in FIG. 1 as seen from above.

FIG. 5 is another exploded perspective view of the image projector illustrated in FIG. 1.

FIG. 6A is a fourth plan view of the image projector illustrated in FIG. 1 as seen from above.

FIG. 6B is a cross-sectional view of a configuration example of a cross-section of the image projector illustrated in FIG. 6A.

### DESCRIPTION OF THE EMBODIMENTS

Embodiments of the present disclosure will now be described in detail with reference to the drawings. Note that descriptions will be provided in the following order.

1. Embodiments

2. Modifications

### 1. Embodiments

### [1.1 Schematic Configuration of Image Projector 100]

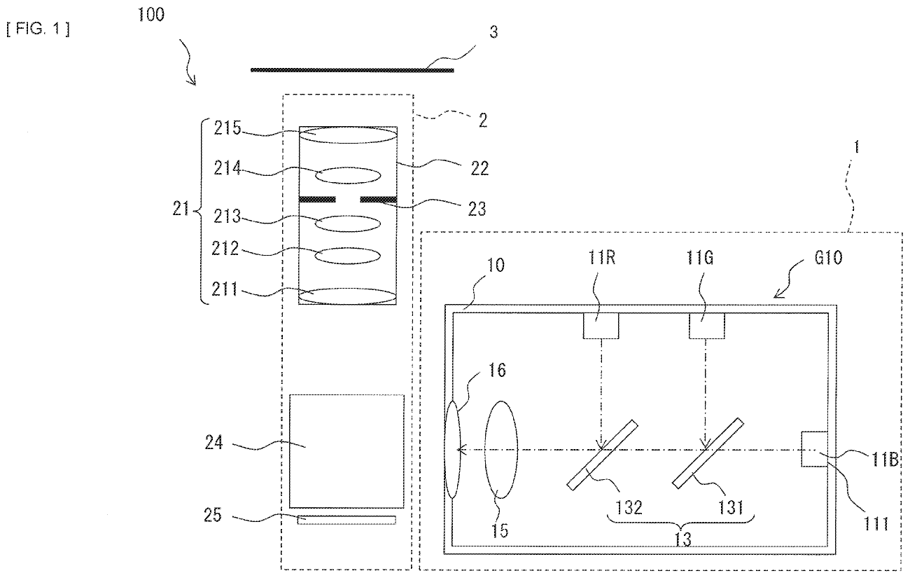

FIG. 1 illustrates the overall configuration of an image projector 100 according to an embodiment of the present disclosure. The image projector 100 is a projection display unit that projects an image (image light) on a screen 3 (a projected surface). The image projector 100 includes an illumination optical system 1 and a projection optical system 2 that uses illumination light from the illumination optical system 1 to display images. The illumination optical system 1 and the projection optical system 2 are fixed to each other to maintain an appropriate positional relation. Note that it is possible to apply the image projector 100 to a stationary television set as well as an in-vehicle head-up display (HUD).

### (Illumination Optical System 1)

The illumination optical system 1 includes a housing 10 (described below) accommodating at least one red laser 11R, at least one green laser 11G, and at least one blue laser 11B. In this specification, these may collectively be referred to as laser sources 11. Furthermore, the illumination optical system 1 includes dichroic mirrors 13 (131, 132), an integrator lens 15, and a condenser lens 16. Note that the dashed-dotted lines in the drawing represent example ray paths of the respective colors. The laser sources 11, the coupling lens 12, the dichroic mirrors 13, the integrator lens 15, and the condenser lens 16 are collectively referred to as an optical device group G10.

The red laser 11R, the green laser 11G, and the blue laser 11B are three types of laser sources respectively emitting a red laser beam, a green laser beam, and a blue laser beam.

The dichroic mirror 131 is a mirror that selectively transmits the blue laser beam from the blue laser 11B and selectively reflects the green laser beam from the green laser 11G.

The dichroic mirror 132 is a mirror that selectively transmits the blue laser beam and the green laser beam outputted from the dichroic mirror 131 and selectively reflects the red laser beam from the red laser 11R. In this way, color synthesis (optical path combining) of the red laser beam, the green laser beam, and the blue laser beam is performed in the illumination optical system 1.

The integrator lens 15 spatially divides an incoming beam and outputs the divided beams. The integrator lens 15 uniformizes the light outputted from the integrator lens 15 (i.e., uniformizes the in-plane distribution of light intensity).

The condenser lens 16 is a lens that condenses light outputted from the integrator lens 15 and outputs the condensed light as illumination light to the outside.

### (Projection Optical System 2)

The projection optical system 2 includes, for example, a housing 20 (described below) provided with a lens barrel 22 accommodating a lens group 21 and a diaphragm 23, a polarization beam splitter (PBS) 24, and a light valve 25 as a light modulation device. The lens group 21 includes, for example, at least one lens (lens 211 to 215 in this embodiment).

The lens group 21 projects illumination light (image light) modulated by the light valve 25 to the screen 3 (enlarged projection). Note that, in the present technology, the number of lens included in the lens group 21 is not limited to a particular number.

The PBS 24 is a polarization splitting device outputting polarization components different from each other (a p-polarization component and an s-polarization component) in directions different from each other.

The light valve 25 is a reflective liquid crystal device, such as a liquid crystal on silicon (LCOS), for example. The light valve 25 modulates, for example, illumination light (for example, the s-polarization component) from the illumination optical system 1 on the basis of an image signal.

### [1.2 Detailed Configuration of Image Projector 100]

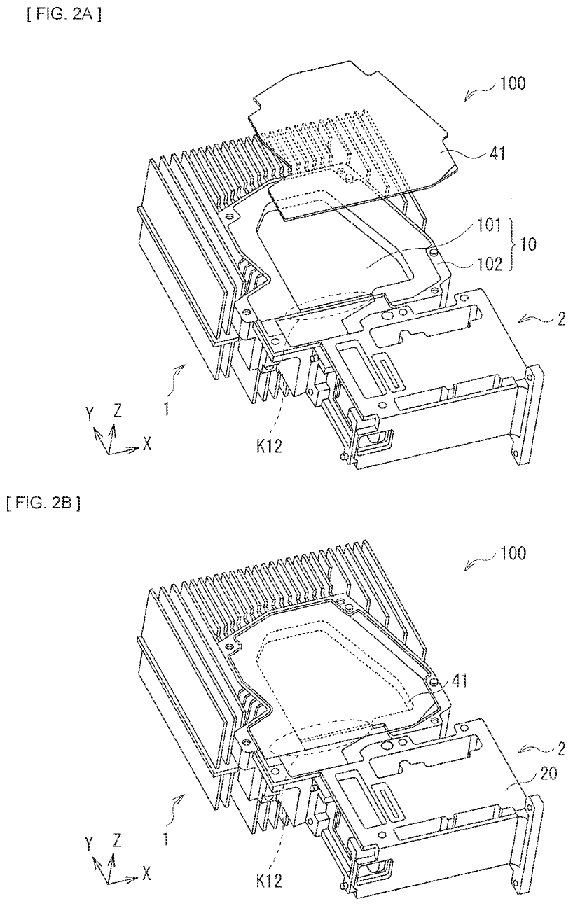

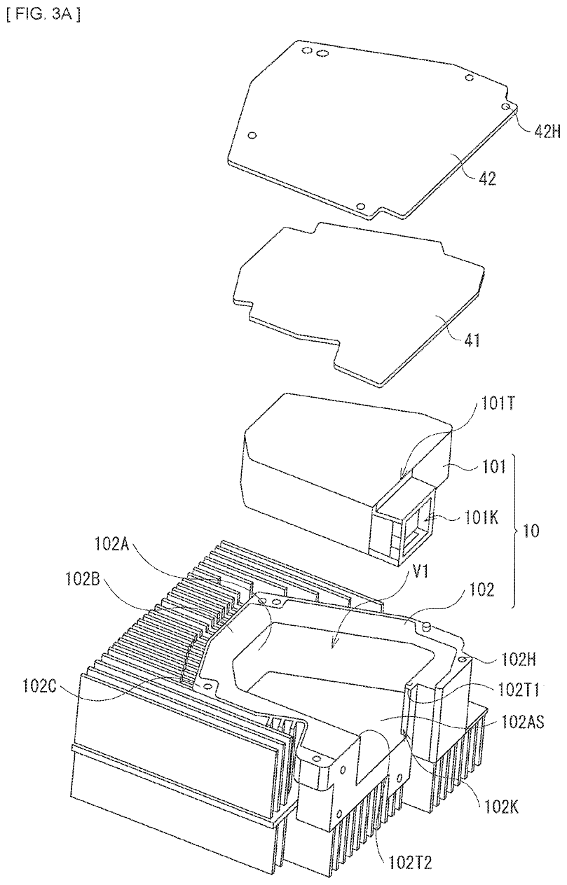

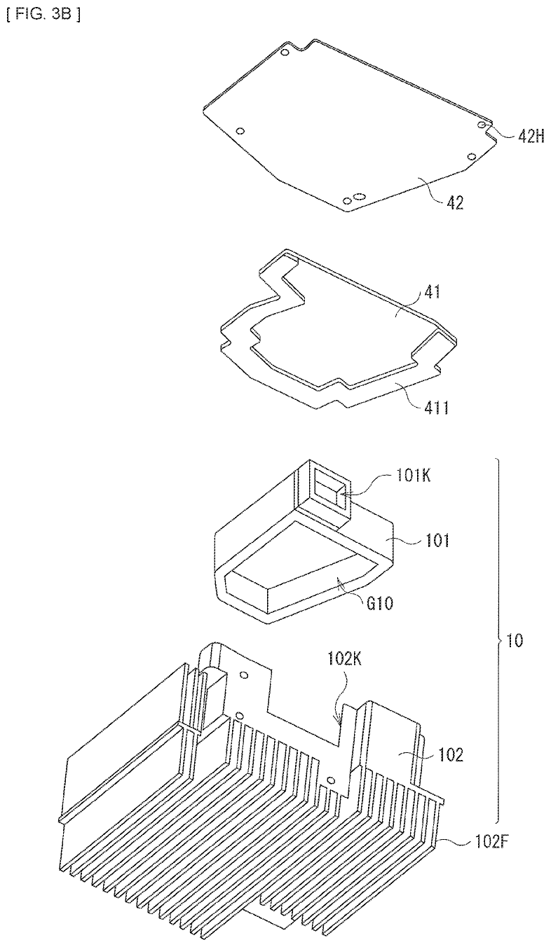

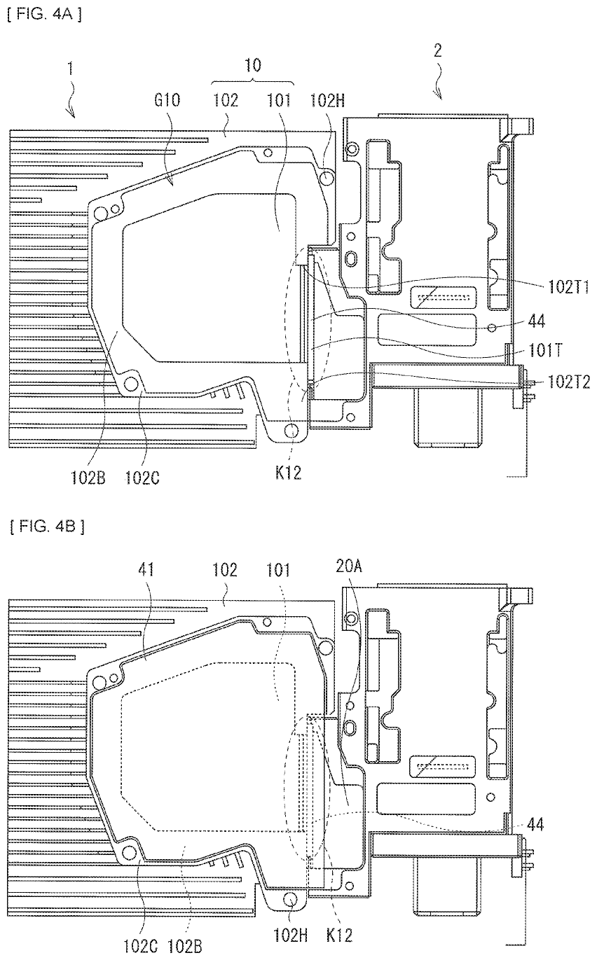

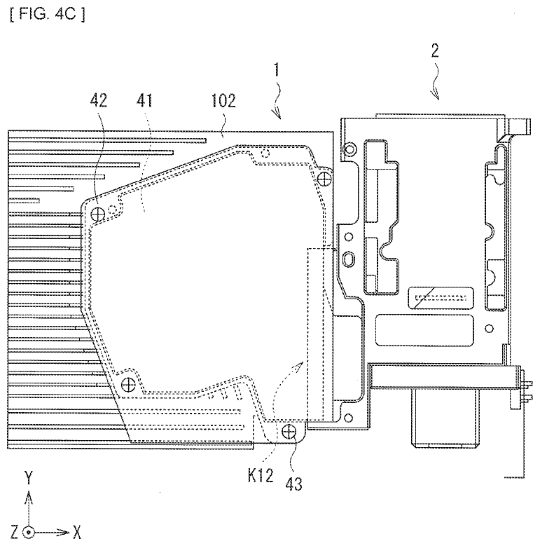

The detailed configuration of the image projector 100 will now be described with reference to FIGS. 2A to 6B. FIGS. 2A and 2B are exploded perspective views of the image projector 100. FIGS. 3A and 3B are exploded perspective views of the illumination optical system 1. Note that FIGS. 2A and 2B do not illustrate the cover 42 (described below). Note that FIG. 3A illustrates the illumination optical system 1 viewed from obliquely above, and FIG. 3B illustrates the illumination optical system 1 viewed from obliquely below. Furthermore, FIGS. 4A to 4C illustrate the image projector 100 viewed from above. FIG. 4A illustrates a state in which both the seal 41 (described below) and the cover 42 are removed. FIG. 4B illustrates a state in which the cover 42 is removed. FIG. 4C illustrates a state in which both the seal 41 and the cover 42 are attached.

### (Illumination Optical System 1)

As illustrated in FIG. 2A, the housing 10 of the illumination optical system 1 includes a chassis 101 and a heat sink 102. The optical device group G10 is fixed to the chassis 101 and accommodated in a compartment 102A of the heat sink 102 together with the chassis 101. The heat sink 102 is a member that dissipates heat generated mainly at the laser sources 11 to the outside. The back faces 111 of the laser sources 11 are exposed on the chassis 101. The back faces 111 are indirectly in contact with the wall face of the compartment 102A of the heat sink 102 via, for example, a heat radiating agent. This is to efficiently propagate the heat generated near and at the back faces 111 to the heat sink 102 because the main heat-emitting areas of the laser sources 11 are located near and at the back faces 111. Note that the back faces 111 of the laser sources 11 may be in direct contact with the wall face of the compartment 102A of the heat sink 102. In the illumination optical system 1, the seal 41 is disposed to cover the entire chassis 101 accommodated in the compartment 102A of the heat sink 102. Here, the housing 10 is a specific example corresponding to a “container” according to the present invention. The chassis is a specific example corresponding to a “first chassis” according to the present invention. The heat sink 102 is a specific example corresponding to a “second chassis” according to the present invention. The compartment 102A is a specific example corresponding to a “depression” according to the present invention. The seal 41 is a specific example corresponding to a “seal” or a “first seal” according to the present invention.

The chassis 101 of the housing 10 accommodates the optical device group G10 including the laser sources 11, as described above. Thus, the chassis 101 has an output window 101K through which the illumination light from the laser sources 11 is outputted toward the projection optical system 2. The output window 101K is exposed to the outside of the illumination optical system 1. The portion of the chassis 101 other than the output window 101K is covered with the heat sink 102 and the seal 41. Furthermore, the chassis 101 further has a top portion 101T disposed at a height position substantially the same as that of a flange face 102B described below.

The heat sink 102 further includes a flange face 102B that abuts the peripheral edge portion of the seal 41 and surrounds the compartment 102A. Furthermore, the heat sink 102 has a cutout 102K that leads the output window 101K to the outside of the compartment 102A. The flange face 102B has open ends 102T1 and 102T2 in areas on the plane (XY plane) extending from the flange face 102B, specifically, in areas corresponding to the cutout 102K. The top portion 101T of the chassis 101 is inserted between the open end 102T1 and the open end 102T2. The open ends 102T1 and 102T2 and the top portion 101T are disposed at substantially the same height positions. Thus, the flange face 102B and the top portion 101T are connected to surround the entire compartment 102A. Furthermore, the gap between the open end 102T1 and the top portion 101T and the gap between the open end 102T2 and the top portion 101T are both sealed by being covered with the seal 41. Furthermore, the outer face of the heat sink 102 may be provided with a plurality of fins 102F. This is because it is possible to increase the contact area of the heat sink 102 and the outside air, and efficiently release the heat generated at the laser sources 11, etc., to the outside space.

Furthermore, as illustrated in FIGS. 3A, 3B, and 4C, the image projector 100 further includes a cover 42 attached to the housing 10 to cover the entire seal 41. It is desirable that the cover 42 include a plate-like rigid member having high rigidity, such as stainless steel, for example. The peripheral edge portion of the cover 42 is an excess portion protruding outward from the outer edge of the seal 41. The peripheral portion of the cover 42 is provided with a plurality of through-holes 42H passing through the cover 42 in the thickness direction (Z-axis direction).

The seal 41 is a sealing member that defines a sealed space V1 between the seal 41 and the compartment 102A by abutting the peripheral edge portion of the seal 41 to the flange face 102B, and functions to seal the compartment 102A accommodating the optical device group G10. The seal 41 is, for example, a sheet-like member having elasticity. The seal 41 is held between the flange face 102B of the heat sink 102 and the cover 42. This is because, even if there is a step on the flange face 102B or a step between the heat sink 102 and another component, the seal 41 absorbs the step with its elasticity and enables ready maintenance of the hermeticity of the sealed space V1. It is particularly desirable that the seal 41 be a foam having airtightness and including multiple closed pores. This is because the closed pores are not connected with each other, and thus it is possible to prevent dust and the like from entering the sealed space V1 through the seal 41. An example of a material suitable as a constituent material of the seal 41 is, for example, “XLIM” available from Sekisui Chemical Co., Ltd.

Furthermore, the peripheral edge portion of the seal 41 may be in tight contact with the flange face 102B of the heat sink 102 via an adhesive layer 411 including an adhesive agent or the like (see FIG. 3B). This is because the hermeticity of the optical device group G10 is even more enhanced. The adhesive layer 411 is a specific example corresponding to an “adhesive layer” and a “first adhesive layer” according to the present invention.

The heat sink 102 further includes a flange face 102C disposed to further surround the flange face 102B abutting the peripheral edge portion of the seal 41. The flange face 102C abuts the peripheral edge portion of the cover 42 covering the seal 41. The flange face 102C has screw holes 102H formed at positions corresponding to the plurality of through-holes 42H provided in the peripheral edge portion of the cover 42. Thus, fitting screws 43 passing through the through-holes 42H with the screw holes 102H firmly fastens the cover 42 to the heat sink 102 while the seal 41 is held between the cover 42 and the flange face 102B. Hence, it is possible to prevent the formation of a gap between the seal 41 and the flange face 102B due to separation of the seal 41.

Here, when the bottom face 102AS of the compartment 102A is disposed at a reference height position (a position along the Z-axis direction), the height position of the flange face 102C is slightly higher than the height position of the flange face 102B. The difference between the height position of the flange face 102C and the height position of the flange face 102B may be, for example, smaller than or equal to the thickness of the seal 41 (a dimension in the Z-axis direction). This is because the peripheral edge portion of the seal 41 is held between the flange face 102C and the peripheral edge portion of the cover 42, to bring the flange face 102C and the seal 41 into tight contact without a gap therebetween. In particular, it is desirable that the seal 41 be an elastic member, and the difference between the height position of the flange face 102C and the height position of the flange face 102B be smaller than the thickness of the seal 41. This is to further enhance the hermeticity of the optical device group G10.

(Configuration of Vicinity of Boundary between Illumination Optical System 1 and Projection Optical System 2)

As illustrated in FIGS. 2A, 2B, and 4A to 4C, the seal 41 and the cover 42 are disposed to bridge the gap between the housing 10 of the illumination optical system 1 and the housing 20 of the projection optical system 2 in a boundary area K12 in which the illumination optical system 1 and the projection optical system 2 are coupled.

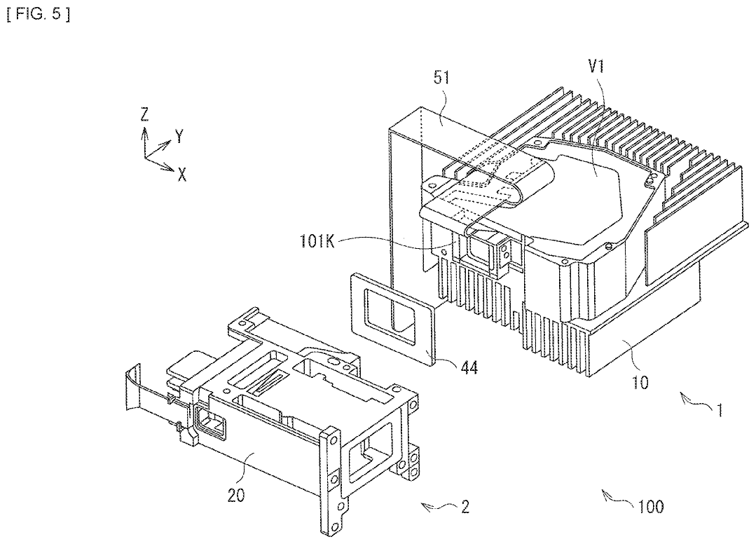

FIG. 5 is an exploded perspective view of the image projector 100 illustrating the configuration in the vicinity of the boundary between the illumination optical system 1 and the projection optical system 2. As illustrated in FIG. 5, the image projector 100 further includes a seal 44 between the illumination optical system 1 and the projection optical system 2. The seal 44 corresponds to a specific example of a “second seal” according to the present invention. The seal 44 is a frame-like sheet that seals the gap between the illumination optical system 1 and the projection optical system 2. The projection optical system 2 has an input window 2K into which the light (illumination light) outputted from the output window 101K of the illumination optical system 1 enters. The seal 44 surrounds both the output window 101K and the input window 2K.

It is desirable that the seal 44 be, for example, a sheet-like member having elasticity, like the seal 41. This is because, even if there is a step in the chassis 101 and the heat sink 102 in the peripheral area of the output window 101K or a step in the housing 20 in the peripheral area of the input window 2K, the seal 44 absorbs the step with its elasticity and enables ready maintenance of a sealed state of the housing 10 and the housing 20. It is particularly desirable that the seal 44 be a foam having airtightness and including multiple closed pores, for example, “XLIM” available from Sekisui Chemical Co., Ltd.

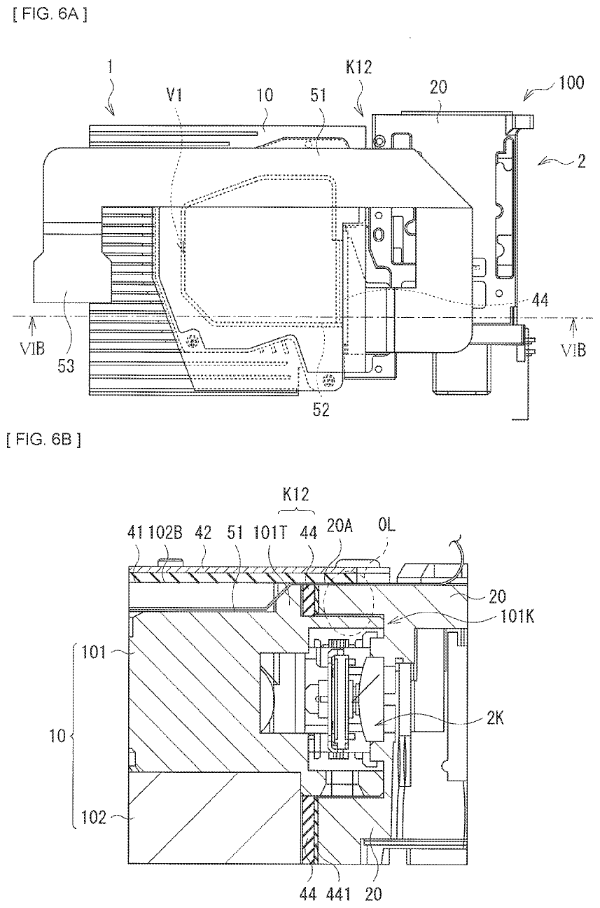

FIG. 6A is a plan view of the image projector 100 as seen from above. FIG. 6B is a cross-sectional view taken along line VI-VI in FIG. 6A and viewed from the direction of the arrows. As illustrated in FIGS. 6A and 5, the image projector 100 includes a flexible printed circuit board 51. The flexible printed circuit board 51 has end portions 52 and 53. The end portion 52 is coupled to the laser sources 11. The end portion 53 is led out from the sealed space V1 sealed by the housing 10 and the seal 41 through between the chassis 101 and the seal 41 to the outside. The seal 41 covers both the flange face 102B of the heat sink 102 and the surface 20A of the housing 20 to bridge the gap between the flange face 102B and the surface 20A. Here, it is desirable that the height position of the flange face 102B and the height position of the surface 20A substantially match each other (see FIG. 6B). This is because a gap is prevented from readily forming between the seal 41 and the flange face 102B (or the flexible printed circuit board 51) or between the seal 41 and the surface 20A (or the flexible printed circuit board 51). Furthermore, it is desirable that the flexible printed circuit board 51 be in contact with the chassis 101 at only the top portion 101T. This is to prevent the flexible printed circuit board 51 from bending or breaking in response to receiving stress. Furthermore, the flexible printed circuit board 51 is held between the seal 41 and the seal 44 near the boundary area K12 and is in tight contact with both the seal 41 and the seal 44. This maintains the sealed state of the sealed space V1.

It is desirable that the seal 44 be bonded to at least one of the housing 10 or the housing 20 via a second adhesive layer or adhesive layer 441, as illustrated in FIG. 6B, for example. It is more desirable that the seal 44 be bonded to both the housing 10 and the housing 20. This is to further enhance the airtightness of the sealed space V1. Note that FIG. 6B illustrates an example in which the adhesive layer 441 is disposed between the seal 44 and the housing 20.

Furthermore, in the image projector 100, it is desirable that, for example, a portion of the housing 10 and a portion of the housing 20 overlap in the coupled area of the illumination optical system 1 and the projection optical system 2. This is to enhance the adhesion between the illumination optical system 1 and the projection optical system 2, and to enhance the hermeticity of the sealed space V1. FIG. 6B illustrates an example state in which an overlapping region OL is formed, the overlapping region OL being where the output window 101K of the chassis 101 and the input window 2K of the housing 20 overlap each other.

### [1.3 Display Operation of Image Projector 100]

First, in the illumination optical system 1 of this display unit, the laser beams of the respective colors (a red laser beam, a green laser beam, and a blue laser beam) respectively emitted from the red laser 11R, the green laser 11G, and the blue laser 11B pass through the dichroic mirrors 131 and 132, the integrator lens 15, and the condenser lens 16, in this order, and enter the PBS 24 as illumination light, as illustrated in FIG. 1. At this time, the integrator lens 15 uniformizes the light entering the PBS 24 (i.e., uniformizes the in-plane distribution of light intensity).

The illumination light input to the PBS 24 enters the light valve 25. At the light valve 25, the illumination light is modulated on the basis of an image signal while being reflected, and is output as an image light. The light outputted from the light valve 25 enters the lens group 21 and is then projected to the screen 3 by the lens group 21 (enlarged projection).

At this time, the red laser 11R, the green laser 11G, and the blue laser 11B each performs an intermittent light-emitting operation based on, for example, a predetermined light-emitting frequency. In this way, the laser beams of the respective colors (a red laser beam, a green laser beam, and a blue laser beam) are sequentially emitted in a time-division manner. Then, the light valve 25 modulates the laser beams corresponding to image signals of the respective color components (a red color component, a green color component, and a blue color component) in sequence in a time-division manner. In this way, the display unit displays a color image based on an image signal.

### [1.4 Operation and Effect of Image Projector 100]

In this way, the illumination optical system 1 according to this embodiment includes the optical device group G10 including the laser sources 11, the housing 10 accommodating the optical device group G10, and the seal 41 attached to the housing 10 to cover the optical device group G10, the seal 41 sealing in the optical device group G10. Hence, the optical device group G10 is accommodated in the sealed space V1 of the housing 10 and sealed in by the seal 41. This suppresses degradation of the optical performance due to the influence of dust. Thus, the image projector 100 including the illumination optical system 1 enables satisfactory display performance. Furthermore, it is possible to produce the image projector 100 according to this embodiment more readily in comparison to a structure on which a sealant, such as resin, is applied.

In the case where a laser source is used, fine particles and dust readily attach to the optical members, such as lenses, due to a so-called optical dust collection effect. Such an optical dust collection effect tends to occur when a laser beam having a wavelength of, for example, approximately 350 nm to 500 nm is transmitted through or reflected at an optical member. Fine particles or dust attached to an optical member cause a reduction in the transmittance and/or reflectance due to such an optical dust collection effect. Furthermore, in general, an image projector using laser sources is suited for size reduction. However, such a size reduction causes a reduction in lens diameter. This leads to susceptibility to dirt, dust, or the like attached to a lens surface. Thus, in this embodiment, the optical device group G10 including the laser sources 11 is accommodated in the compartment 102A of the heat sink 102 and sealed in with the seal 41. Such a structure enables effective prevention of intrusion of dust, cigarette smoke, etc., from the outside.

In particular, in this embodiment, the hermeticity of the sealed space V1 is readily maintained when the seal 41 is a sheet-like member having elasticity.

Furthermore, since the seal 41 and the cover 42 overlap to cover also the gap between the illumination optical system 1 and the projection optical system 2 in the boundary area K12, it is possible to accommodate the optical device group G10 in the sealed space V1 with enhanced hermeticity. In particular, since the cover 42 is attached to the heat sink 102 to cover the entire seal 41, it is possible to enhance the adhesiveness between the seal 41 and the heat sink.

Furthermore, a step is provided between the flange face 102B, where the heat sink 102 abuts the seal 41, and the flange face 102C, where the heat sink 102 abuts the cover 42. Hence, the height position of the upper face of the seal 41 abutting the flange face 102B, which is the face of the seal 41 remote from the flange face 102B, is higher than the height position of the flange face 102C. Thus, the attachment of the cover 42 highly effectively prevents formation of a gap between the seal 41 and the heat sink.

Furthermore, in this structure, hermeticity is enhanced by surrounding the chassis 101 to which the optical device group G10 is attached with the heat sink 102 and the seal 41 while the back faces 111 of the laser sources 11, which are the main heat source, are brought into contact with the heat sink 102 via, for example, a heat radiating agent. This allows high heat radiation performance to be maintained.

Additionally, the seal 44 is provided to seal the gap between the illumination optical system 1 and the projection optical system 2. This enables more effective prevention of the intrusion of dust, cigarette smoke, and the like from the outside.

### <2. Modification>

Although the present technology has been described above through the embodiments and modifications, the present technology is not limited to the above-described embodiments, etc., and various modifications are possible. For example, the above-described embodiments, etc., describe a case in which the various types of light sources (for the color red, the color green, and the color blue) are all laser sources. However, the light sources are not limited thereto, and other light sources, such as LEDs, for example, may be used. Alternatively, a laser source and another light source, such as an LED, for example, may be combined.

In addition, the above-described embodiments, etc., describe an example case in which the light modulating device is a reflective liquid crystal device. However, the light modulating device is not limited thereto. That is, the light modulating device may be, for example, a transmissive liquid crystal device or any light modulating device other than a liquid crystal device. For example, the light modulating device may be a digital micro-mirror device (DMD), etc.

Furthermore, the above-described embodiments, etc., describe a case of using three types of light sources generating light having different wavelengths. Alternatively, for example, one, two, or four or more types of light sources may be used, besides three types of light sources.

Additionally, the above-described embodiments, etc., describe specific examples of the respective components (optical members) of the illumination optical system and the projection optical system. However, all components do not have to be included, and other components may be further included. Specifically, for example, dichroic prisms may be provided in place of the dichroic mirrors 131 and 132.

Furthermore, the present technology may employ the following configurations.

(1) An Illumination Optical System Including:

an optical device group including a light source;

a container accommodating the optical device group; and

a seal attached to the container to cover the optical device group, the seal sealing in the optical device group.

(2) The illumination optical system according to (1), in which the seal includes a sheet-like member having elasticity.

(3) The illumination optical system according to (2), in which the sheet-like member includes a foam.

(4) The illumination optical system according to any one of (1) to (3), in which the container includes a first chassis and a second chassis, the first chassis accommodating the optical device group and having an output window through which light from the light source is outputted, the second chassis including a depression accommodating the first chassis.

(5) The illumination optical system according to (4), in which the output window of the first chassis is exposed to outside, and a portion of the first chassis other than the output window is covered by the second chassis and the seal.

(6) The illumination optical system according to (4) or (5), in which the second chassis further includes a flange face that abuts the seal and surrounds the depression.

(7) The illumination optical system according to (6), in which the first chassis further includes a top portion disposed at a height position substantially the same as a height position of the flange face.

(8) The illumination optical system according to (7), further including

a flexible printed circuit board including
a first end portion connected with the light source, and
a second end portion led out from a sealed space sealed by the container and the seal through between the first chassis and the seal to outside, in which

the flexible printed circuit board is in contact with the first chassis only at the top portion.

(9) The illumination optical system according to any one of (1) to (8), further including a rigid member attached to the container to entirely cover the seal.

(10) The illumination optical system according to any one of (4) to (8), in which the seal adheres to the second chassis via an adhesive layer.

(11) An image projector including:

an illumination optical system; and

a projection optical system,

in which the illumination optical system includes
an optical device group including a light source,
a container accommodating the optical device group, and
a first seal attached to the container to cover the optical device group, the first seal sealing in the optical device group.

(12) The image projector according to (11), further including

a second seal sealing a gap between the illumination optical system and the projection optical system, in which,

the container includes a first chassis and a second chassis, the first chassis accommodating the optical device group and having an output window through which light from the light source is outputted, the second chassis including a depression accommodating the first chassis,

the projection optical system has an input window in which light outputted through the output window enters, and

the second seal surrounds both the output window and the input window.

(13) The image projector according to (12), in which the first seal and the second seal each includes a sheet-like member having elasticity.

(14) The image projector according to (12) or (13), in which the first seal adheres to the second chassis via a first adhesive layer.

(15) The image projector according to any one of (12) to (14), in which the second seal adheres to at least one of the illumination optical system or the projection optical system via a second adhesive layer.

(16) The image projector according to any one of (11) to (15), in which the first seal is disposed to bridge a gap between the illumination optical system and the projection optical system.

(17) The image projector according to any one of (12) to (15), further including a flexible printed circuit board including:

a first end portion connected with the light source; and

a second end portion led out from a sealed space sealed by the container and the first seal through between the first chassis and the first seal to outside,

in which the flexible printed circuit board is disposed between the first seal and the second seal, the flexible printed circuit board being in tight contact with both the first seal and the second seal.

(18) The image projector according to any one of (11) to (17), further including:

a rigid member attached to the container to entirely cover the first seal.

(19) The image projector according to (18), in which the rigid member is disposed to bridge a gap between the illumination optical system and the projection optical system.

This application claims priority on the basis of Japanese Patent Application No. 2017-59756 filed with the Japan Patent Office on Mar. 24, 2017, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

1. An illumination optical system comprising:
an optical device group including a light source;
a container accommodating the optical device group; and
a seal attached to the container to cover the optical device group, the seal sealing in the optical device group.

2. The illumination optical system according to claim 1, wherein the seal includes a sheet-like member having elasticity.

3. The illumination optical system according to claim 2, wherein the sheet-like member includes a foam.

4. The illumination optical system according to claim 1, wherein the container includes a first chassis and a second chassis, the first chassis accommodating the optical device group and having an output window through which light from the light source is outputted, the second chassis including a depression accommodating the first chassis.

5. The illumination optical system according to claim 4, wherein the output window of the first chassis is exposed to outside, and a portion of the first chassis other than the output window is covered by the second chassis and the seal.

6. The illumination optical system according to claim 4, wherein the second chassis further includes a flange face that abuts the seal and surrounds the depression.

7. The illumination optical system according to claim 6, wherein the first chassis further includes a top portion disposed at a height position substantially the same as a height position of the flange face.

8. The illumination optical system according to claim 7, further comprising
a flexible printed circuit board including
a first end portion connected with the light source, and
a second end portion led out from a sealed space sealed by the container and the seal through between the first chassis and the seal to outside, wherein
the flexible printed circuit board is in contact with the first chassis only at the top portion.

9. The illumination optical system according to claim 1, further comprising a rigid member attached to the container to entirely cover the seal.

10. The illumination optical system according to claim 4, wherein the seal adheres to the second chassis via an adhesive layer.

11. An image projector comprising:
an illumination optical system; and
a projection optical system,
wherein the illumination optical system includes
an optical device group including a light source,
a container accommodating the optical device group, and
a first seal attached to the container to cover the optical device group, the first seal sealing in the optical device group.

12. The image projector according to claim 11, further comprising
a second seal sealing a gap between the illumination optical system and the projection optical system, wherein,
the container includes a first chassis and a second chassis, the first chassis accommodating the optical device group and having an output window through which light from the light source is outputted, the second chassis including a depression accommodating the first chassis,
the projection optical system has an input window in which light outputted through the output window enters, and
the second seal surrounds both the output window and the input window.

13. The image projector according to claim 12, wherein the first seal and the second seal each includes a sheet-like member having elasticity.

14. The image projector according to claim 12, wherein the first seal adheres to the second chassis via a first adhesive layer.

15. The image projector according to claim 12, wherein the second seal adheres to at least one of the illumination optical system or the projection optical system via a second adhesive layer.

16. The image projector according to claim 11, wherein the first seal is disposed to bridge a gap between the illumination optical system and the projection optical system.

17. The image projector according to claim 12, further comprising a flexible printed circuit board including:
a first end portion connected with the light source; and
a second end portion led out from a sealed space sealed by the container and the first seal through between the first chassis and the first seal to outside,
wherein the flexible printed circuit board is disposed between the first seal and the second seal, the flexible printed circuit board being in tight contact with both the first seal and the second seal.

18. The image projector according to claim 11, further comprising a rigid member attached to the container to entirely cover the first seal.

19. The image projector according to claim 18, wherein the rigid member is disposed to bridge a gap between the illumination optical system and the projection optical system.
